(19) United States
(12) Patent Application Publication
(10) Pub. No.: US 2015/0172244 A1
(43) Pub. Date: Jun. 18, 2015

(54) Group management method and server in mobile social network service application

(71) Applicant: OPENVACS CO., LTD., Seoul (KR)

(72) Inventor: Yeongmin Jeong, Gyeonggi-do (KR)

(73) Assignees: OPENVACS CO., LTD., Seoul (KR); Yeongmin Jeong, Gyeonggi-do (KR)

(21) Appl. No.: 14/413,645

(22) PCT Filed: Jun. 12, 2013
(86) PCT No.: PCT/KR2013/005195

§ 371 Date: Jan. 8, 2015

(30) Foreign Application Priority Data
Jul. 11, 2012 (KR) 10-2012-0075309

(51) Int. Cl. H04L 12/58

(52) U.S. Cl. CPC H04L 51/14; H04L 51/32; H04L 51/04

(57) ABSTRACT

The present invention relates to a group management method and server in a mobile social network service application. According to the present invention, instant messages of a mobile social network service application are confirmed to corresponding to a preset grouping target, the instant messages are filtered in real time, and only instant messages corresponding to the grouping target are provided to a mobile terminal, which sets grouping targets, and displayed. Thus, user satisfaction can be increased.

### TECHNICAL FIELD

The present invention relates to a method of managing groups in a mobile social network service application and a group management server, and more particularly, to a method of managing groups in a mobile social network service application such that a user of a mobile terminal may see only an instant message of a preset group and a group management server for performing the same.

### BACKGROUND ART

A mobile terminal is a portable device having one or more functions of performing a voice call and/or a video call, inputting and outputting information, storing data, and the like. The mobile terminal, as having various functions, is provided with complicated functions such as of shooting a still picture and/or a motion picture, playing music files and/or motion pictures, receiving games and/or broadcasting, performing wireless internet and is being implemented as a general multimedia device. In recent, the mobile terminal implemented as a multimedia device is provided with various supplementary functions.

For example, the mobile terminal provides a mobile instant messenger service or a mobile social network service in recent years. Particularly, Korean Patent Publication No, 10-2007-0031099 entitled “Method of providing a chatting service by a mobile instant messenger of a mobile terminal and system for performing the same” suggests a method of enabling a user who receives a request for the chatting service to use a mobile chatting service even during a standby time when the user downloads various network setting information during login in the mobile instant messenger, when the user drives the mobile instant messenger loaded in the mobile terminal to use the chatting service.

Moreover, since a mobile social network service application displays all instant messages transmitted to a mobile terminal that receives the instant messages such that even messages which a user does not need to read may be displayed, it is desired that only messages of a desired group are filtered and displayed in real time based on user setting so that user satisfaction may be improved.

### DISCLOSURE

### Technical Problem

The present invention provides a method of managing groups in a mobile social network service application by confirming whether an instant message of a mobile social network service application is one of preset grouping target information and of performing filtering thereof in real time, and providing only an instant message belonging to the preset grouping target information to a mobile terminal which presets the preset grouping target information to display such that a user may read a desired message, and a group management server for performing the same.

### Technical Solution

In accordance with one aspect, the present invention provides a method of managing groups in a mobile social network service application performed by a group management server accessed to a first mobile terminal and a second mobile terminal via a wireless communication network including: storing, by a database, regional information, gender information, age information and friend information provided from the first mobile terminal; receiving, by an instant message receiver, an instant message of the mobile social network service application from the second mobile terminal; performing, by a filtering unit, filtering by determining whether the received instant message corresponds to the stored grouping target information in real time; and transmitting, by a transmitter, the received instant message to the first mobile terminal to display when the instant message received from the second mobile terminal satisfies a condition preset by the grouping target information as a result of the filtering.

In this case, the regional information is information about one's native place or a current place, while the information about the current place is acquired from a global positioning system (GPS) or an IP broadband.

The grouping target information is target keyword information generated by a manipulation signal in the first mobile terminal.

After the operation of transmitting the instant message, the first mobile terminal further includes displaying only an instant message satisfying the condition preset by the grouping target information on a screen.

After the operation of transmitting the instant message, the first mobile terminal further includes displaying other users around the user in the form of a list or a map including other users around the user according to a signal to select one of a list menu and a map menu.

When any one other user is selected from other users around the user while other users around the user are displayed in the form of a list, the first mobile terminal calls a profile of the selected other user around the user and displays the profile.

After the operation of transmitting the instant message, the first mobile terminal further comprises receiving and displaying a thumb nail image generated by classifying other users around the user according to a distance or nation.

In accordance with another aspect, the present invention provides a group management server including: a database storing grouping target information provided from a first mobile terminal; an instant message receiver receiving an instant message of a mobile social network service application from a second mobile terminal; a filtering unit performing filtering by confirming whether the received instant message belongs to the stored grouping target information in real time; and an instant message transmitter transmitting only an instant message to the first mobile terminal when the received instant message belongs to the grouping target information as a result of the filtering.

### Advantageous Effects

According to the present invention, only instant messages of a desired group are filtered based on user setting of a mobile terminal using a mobile social network service application to display in real time so that user satisfaction may be improved. Moreover, only information of a group selected by a user may be shared.

### DESCRIPTION OF DRAWINGS

FIG. 1 is a schematic diagram illustrating a group management system for a mobile social network service application according an embodiment of the present invention;

FIG. 2 is a block diagram illustrating a group management server according to an embodiment of the present invention;

FIG. 3A is a view illustrating a community setting screen according to an embodiment of the present invention;

FIG. 3B is a view illustrating a profile setting screen according to an embodiment of the present invention;

FIG. 4 is a block diagram illustrating a mobile terminal according to a second embodiment of the present invention;

FIG. 5A is a view illustrating a bulletin screen of a selected region according to an embodiment of the present invention;

FIG. 5B is a view illustrating a regional searched result screen according to an embodiment of the present invention; and

FIG. 6 is a flowchart illustrating a group management method in a mobile social network service application according to an embodiment of the present invention.

### BEST MODE

Hereinafter, the present invention will be described in detail with reference with the accompanying drawings.

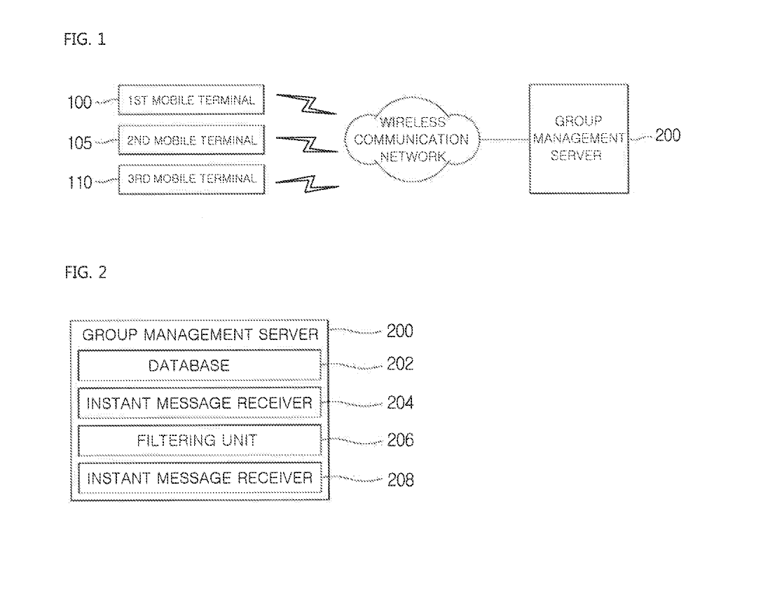

FIG. 1 is a schematic diagram illustrating a group management system for a mobile social network service application according an embodiment of the present invention.

Referring to FIG. 1, a group management system for a mobile social network service application according to an embodiment of the present invention may include a first mobile terminal, a second mobile terminal, and a third mobile terminal 100, 105, and 110m and a group management server 200.

The group management server 200, for example, may receive grouping target information preset by a user of the first mobile terminal 100.

In this case, the grouping target information may be one of regional information about one's native place or a current region, gender, age, friends. The grouping target information may be target keyword information preset in the first mobile terminal 100 in which the grouping target information are preset.

When an instant message of a mobile social network service (SNS) application such as Twitter, KakaoTalk, and the like, for example, is received from the second mobile terminal 105, the group management server 200 may confirm whether the received instant message is the stored grouping target information and perform filtering in real time.

The group management server 200 may transmit only the message that is the message to be grouped as a result of the filtering to the first mobile terminal 100 in which the grouping target information are preset.

That is, for example, when the instant message received from the second mobile terminal 105 is the message to be grouped, the instant message may be transmitted to the first mobile terminal 100. Meanwhile, when an instant message received from the third mobile terminal 110 is not the message to be grouped, the instant message may not be transmitted to the first mobile terminal 100.

By doing so, the first mobile terminal 100 in which the grouping target information are preset may display only the transmitted message corresponding to the grouping target information on a screen.

The first mobile terminal 100 in which the grouping target information are preset may display other users around the user in the form of a list or a map involving other user around the user according to the user's choice of a list menu and a map menu.

The first mobile terminal 100 in which the grouping target information are preset may receive thumb nail images generated by classified other users around the user by distance or nations from the group management server 200 to display.

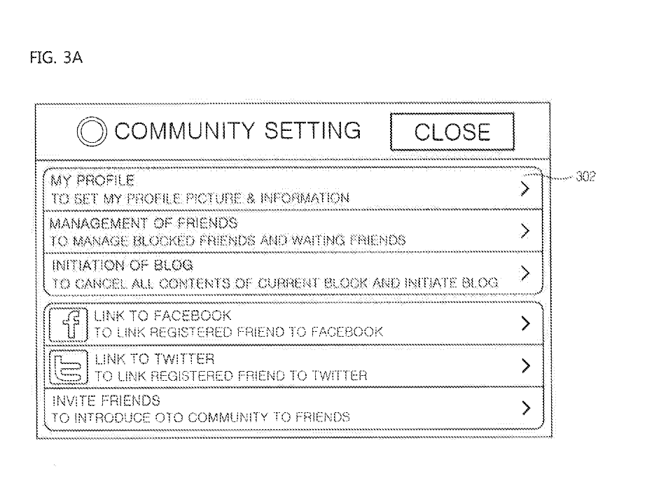

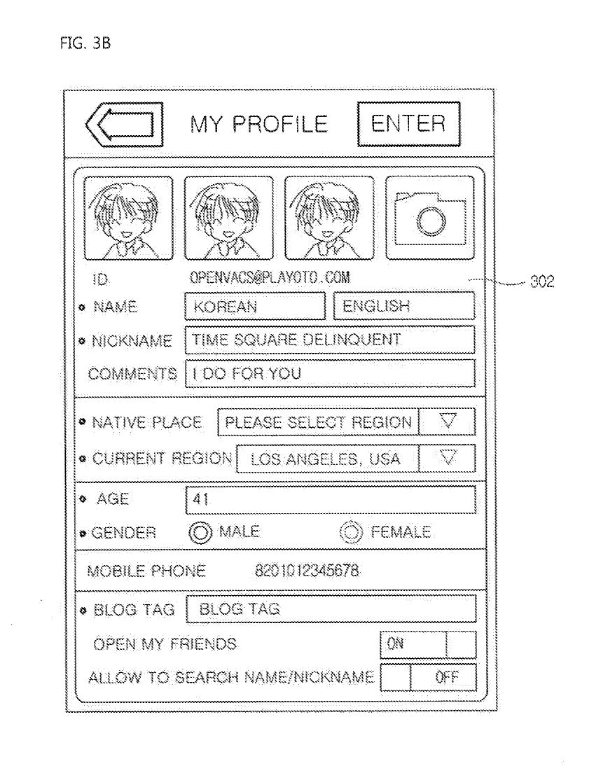

FIG. 2 is a block diagram illustrating a group management server according to an embodiment of the present invention, FIG. 3A is a view illustrating a community setting screen according to an embodiment of the present invention, and FIG. 3B is a view illustrating a profile setting screen according to an embodiment of the present invention.

Referring to drawings, the group management server 200 according to an embodiment of the present invention may include a database 202, an instant message receiver 204, a filtering unit 206, and an instant message transmitter 208.

The database 202 may store the grouping target information preset by users of the respective mobile terminals with respect to at least one mobile terminal. In this case, a user of the mobile terminal may write profile information through a profile setting screen 312 as shown in FIG. 3B to be displayed by selecting a my profile menu of a community setting screen 302 as shown in FIG. 3A, wherein regional information about one's native place or a current place, gender information, and age information may be provided to the group management server 200 as the grouping target information to store.

That is, the grouping target information may be one of regional information of a one's native place or a current place, gender information, age information, and friend information. Moreover, the grouping target information may be target keyword information preset by a mobile terminal in which the grouping target is preset.

The instant message receiver 204 may receive an instant message of a mobile social network service application from the mobile terminal.

The filtering unit 206 may confirm whether the received instant message corresponds to the grouping target information stored in the database and may perform filtering in real time.

The instant message transmitter 208 may transmit only the instant message when the received instant message corresponds to the grouping reference as a result of the filtering to a mobile terminal in which the grouping target is preset.

The instant message transmitter 208 may transmit the instant message such that the mobile terminal in which the grouping target is preset may display other users around the user in the form of a list or a map involving other users around the user according to the user's choice between a list menu and a map menu.

The instant message transmitter 208 may generate thumb nail images of other users around the user of the mobile terminal in which the grouping target is preset by classifying other users around the user by distance or nations and may transmit the generated thumb nail images to the mobile terminal in which the grouping reference is preset.

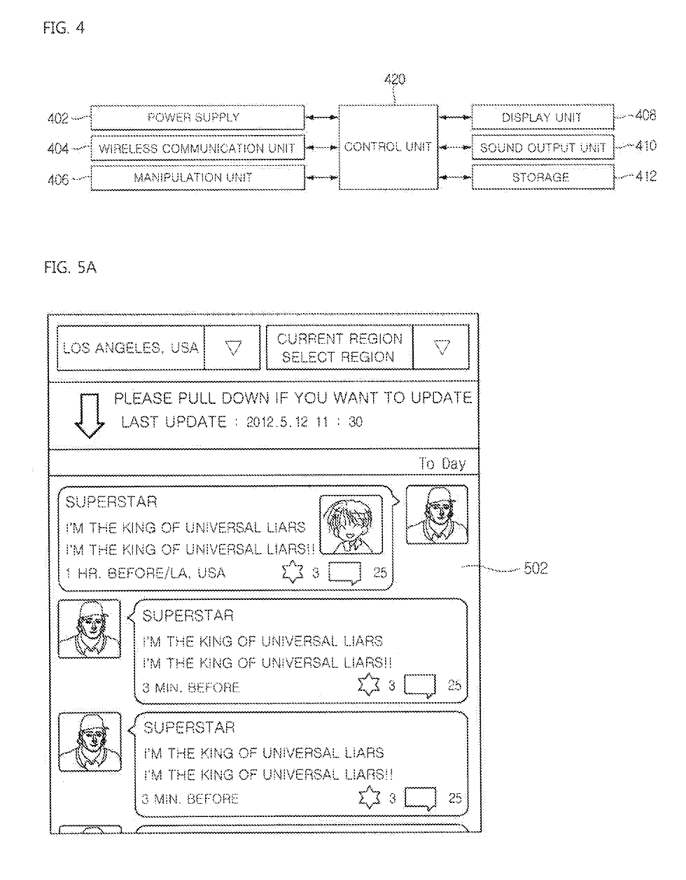

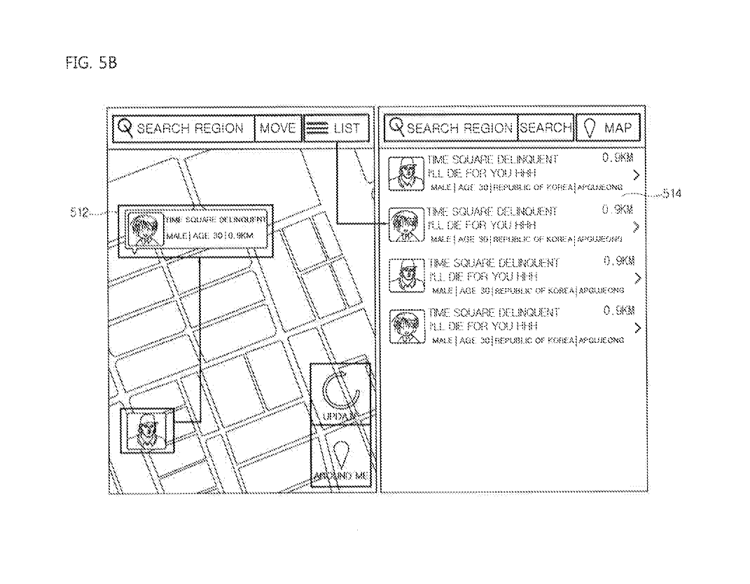

FIG. 4 is a block diagram illustrating a mobile terminal according to a second embodiment of the present invention, FIG. 5A is a view illustrating a bulletin screen of a selected region according to an embodiment of the present invention, and FIG. 5B is a view illustrating a regional searched result screen according to an embodiment of the present invention.

Referring to drawings, a mobile terminal according to an embodiment of the present invention may include a power supply 402, a wireless communication unit 404, a manipulation unit 406, a display unit 408, a sound output unit 410, a storage 412, and a controller 420. The mobile terminal employed in this embodiment of the present invention may be a smartphone.

The power supply 402 may receive an electric power from an exterior power supply or an internal electric power by control of the controller 420 and supply an electric power required to operate respective elements.

The wireless communication unit 404 may include a mobile communication module, a wireless internet module, and a near field communication module. In this case, the mobile communication module transmits and receives a wireless signal of a station within a mobile communication network. Here, the wireless signal may include a voice call signal, a video call signal, or various data related to text/multimedia message transmission. The wireless internet module is a module for wireless internet access and the near field communication module is a module for the near field communication. Wireless internet technologies such as wireless LAN (WLAN; Wi-Fi), wireless broadband (Wibro), world interoperability for microwave access (Wimax), and high speed downlink packet access (HSDPA) may be employed. Moreover, the wireless communication unit 404 may perform a wireless communication with the group management server through the wireless Internet module.

The manipulation unit 406 generates key input data for a user to input for the control of the mobile terminal. The manipulation unit may include a keypad, a dome switch, a touch pad, and the like. Particularly, the touch pad may be a touch screen forming a layer structure in association with the later-described display unit. A user of a mobile terminal may set the grouping target through the manipulation unit 106 so that the mobile terminal may transmit the grouping target information to the group management server through the wireless communication unit 404.

The display unit 408 outputs information processed in the mobile terminal. For example, when the mobile terminal is in a call mode, the display unit displays a user interface (UI) or a graphic user interface (GUI) related to a call. When the mobile terminal is in a video call mode or a shooting mode, the display unit may display the shot or received images respectively or simultaneously. The display unit may include at least one of a liquid crystal display, a thin film transistor-liquid crystal display, an organic light-emitting diode, a flexible display, a 3D display.

Moreover, the display unit 408 may display only the instant message corresponding to the grouping target transmitted from the group management server.

The display unit 408 may display a selected region bulletin screen 502 as shown in FIG. 5A. In this case, a region where a user of the mobile terminal, such as Los Angeles, USA lives is selected and then bulletin of the selected region may be displayed. Moreover, the bulletin may be opened to a selected friend or a group page may be called according to settings by a user of the mobile terminal.

The display unit 408 may display a first region searched result screen 512 and a second region searched result screen 512 as shown in FIG. 5B. In this case, the first region searched result screen 512 is displayed when a user selects the map menu from the list menu and the map menu and the second region searched result screen 514 is displayed when a user selects the list menu so that other users around the user may be displayed in the form of a list or a map including other users around the user according to the user's choice.

On the first region searched result screen 512, other users around the user may be displayed in the form of thumb nail images. On the second region searched result screen 514, when a user clicks a user in the list, a corresponding profile page may be called.

The sound output unit 410 may output audio data received through the wireless communication unit or stored in the storage in a call mode.

The storage 412 may store a program to process processing by the controller and a control program or may store inputted or outputted data temporarily. In this case, the storage may include at least one of a flash memory type storage medium, a hard disk type storage medium, a multimedia card micro type storage medium, a card type memory such as an SD memory or an XD memory, RAM, and ROM.

The controller 420 usually controls overall operations of a mobile terminal by controlling operations of respective elements of the mobile terminal. For example, the controller performs control and processing related to a voice call, a data communication, and a video call. The controller 420 may drive an application to implement the group management method in a mobile social network application according to an embodiment of the present invention.

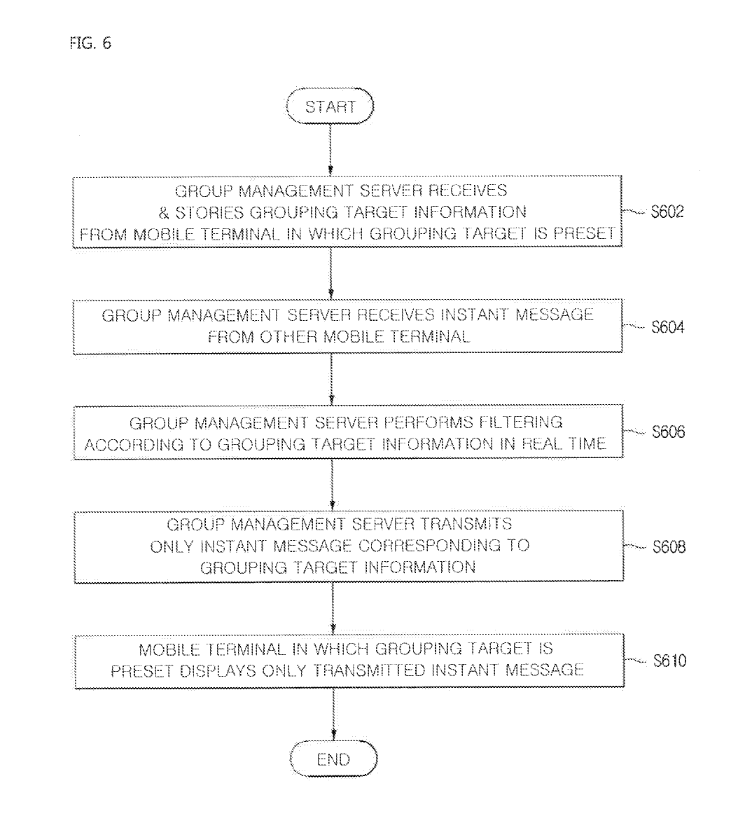

FIG. 6 is a flowchart illustrating a group management method in a mobile social network service application according to an embodiment of the present invention.

A user of a mobile terminal in which the grouping target is preset sets the grouping target to see only a desired instant message in the mobile social network service application, so that the group management server may receive the grouping target information from the mobile terminal in which the grouping target is preset and store the received grouping target information (S602).

In this case, the grouping target information may be any one of regional information about one's native place or a current place, gender information, age information, and friend information. The grouping target information may be target keyword information preset in the mobile terminal in which the grouping target is preset.

The group management server may receive an instant message of a mobile social network service application from not the mobile terminal in which the grouping target is preset but other mobile terminal (S604).

The group management server may confirm whether the received instant message corresponds to the preset grouping target information and may perform filtering in real time (S606).

For example, when the grouping target is a current place, the group management server may perform filtering whether a position of the mobile terminal corresponding to the received instant message belongs to a preset distance from the current position of the mobile terminal in which the grouping target is preset in real time.

Moreover, when the grouping target is a gender, the group management server may perform filtering whether gender of a user of the mobile terminal corresponding to the received instant message belongs to the grouping target in real time.

When the grouping target is age, the group management server may perform filtering whether age of a user of the mobile terminal corresponding to the received instant message belongs to the grouping target in real time.

When the grouping target is a keyword (for example, Ji-Sung Park), the group management server may perform filtering whether the received instant message includes the keyword as the grouping target in real time.

The grouping management server may transmit an instant message to the mobile terminal in which the grouping target is preset when the received instant message belongs to the grouping target as a result of the filtering (S608).

By doing so, the mobile terminal in which the grouping target is preset may display only the instant message belonging to the transmitted grouping target (S610).

The mobile terminal in which the grouping target is preset may display other users around the user in the form of a list or a map including other users around the user according to the user's choice from the list menu and the map menu.

The mobile terminal in which the grouping target is preset may receive and display thumb nail images that are generated by classifying other users around the user by a distance or nation from the group management server.

As such, only instant messages of a desired group are filtered based on user setting of a mobile terminal using a mobile social network service application to display in real time so that user satisfaction may be improved.

While the description of the present invention has been made to the exemplary embodiments, various changes and modifications may be made without departing from the scope of the invention. The embodiment of the present invention is not limited thereto. Therefore, the scope of the present invention should be defined by the appended claims rather than by the foregoing embodiments.

### INDUSTRIAL APPLICABILITY

The present invention may perform group management such that a user may see only a desired instant message in a mobile social network and may contribute advance of IT industries providing mobile messaging service and social network service.

1. A method of managing groups in a mobile social network service application performed by a group management server accessed to a first mobile terminal and a second mobile terminal via a wireless communication network comprising:
storing, by a database, regional information, gender information, age information and friend information provided from the first mobile terminal;
receiving, by an instant message receiver, an instant message of the mobile social network service application from the second mobile terminal;
performing, by a filtering unit, filtering by determining whether the received instant message corresponds to the stored grouping target information in real time; and
transmitting, by a transmitter, the received instant message to the first mobile terminal to display when the instant message received from the second mobile terminal satisfies a condition preset by the grouping target information as a result of the filtering.

2. The method as claimed in claim 1, wherein the regional information is information about one's native place or a current place, while the information about the current place is acquired from a global positioning system (GPS) or an IP broadband.

3. The method as claimed in claim 1, wherein the grouping target information is target keyword information generated by a manipulation signal in the first mobile terminal.

4. The method as claimed in claim 1, wherein, after the operation of transmitting the instant message, the first mobile terminal further comprises displaying only an instant message satisfying the condition preset by the grouping target information on a screen.

5. The method as claimed in claim 1, wherein, after the operation of transmitting the instant message, the first mobile terminal further comprises displaying other users around the user in the form of a list or a map including other users around the user according to a signal to select one of a list menu and a map menu.

6. The method as claimed in claim 5, wherein, when any one other user is selected from other users around the user while other users around the user are displayed in the form of a list, the first mobile terminal calls a profile of the selected other user around the user and displays the profile.

7. The method as claimed in claim 1, wherein, after the operation of transmitting the instant message, the first mobile terminal further comprises receiving and displaying a thumb nail image generated by classifying other users around the user according to a distance or nation.

8. A group management server comprising:
a database storing grouping target information provided from a first mobile terminal;
an instant message receiver receiving an instant message of a mobile social network service application from a second mobile terminal;
a filtering unit performing filtering by confirming whether the received instant message belongs to the stored grouping target information in real time; and
an instant message transmitter transmitting only an instant message to the first mobile terminal when the received instant message belongs to the grouping target information as a result of the filtering.

9. The group management server as claimed in claim 8, wherein the regional information is information about one's native place or a current place, while the information about the current place is acquired from a global positioning system (GPS) or an IP broadband.

10. The group management server as claimed in claim 8, wherein the grouping target information is target keyword information generated by a manipulation signal in the first mobile terminal.

11. The group management server as claimed in claim 8, wherein the first mobile terminal displays only an instant message satisfying the condition preset by the grouping target information on a screen.

12. The group management server as claimed in claim 8, wherein the first mobile terminal displays other users around the user in the form of a list or a map including other users around the user according to a signal to select one of a list menu and a map menu.

13. The group management server as claimed in claim 12, wherein, when any one other user is selected from other users around the user while other users around the user are displayed in the form of a list, the first mobile terminal calls a profile of the selected other user around the user and displays the profile.

14. The group management server as claimed in claim 8, wherein the first mobile terminal further comprises receiving and displaying a thumb nail image generated by classifying other users around the user according to a distance or nation.
